(19) United States
(12) Patent Application Publication
(10) Pub. No.: US 2022/0157162 A1
(43) Pub. Date: May 19, 2022

(54) TRAFFIC STOP COMMUNICATION SYSTEM AND METHOD FOR A DRIVER OF A VEHICLE

(71) Applicant: Marcus Fields, Atlanta, GA (US)

(72) Inventor: Marcus Fields, Atlanta, GA (US)

(21) Appl. No.: 17/589,926

(22) Filed: Feb. 1, 2022

(51) Int. Cl. G08G 1/01; H04N 5/76; H04M 1/72406; H04M 1/72439; H04N 21/2187; H04N 21/4784; G06Q 30/02

(52) U.S. Cl. CPC G08G 1/0141; H04N 5/76; H04M 1/72406; G06F 3/0482; H04N 21/2187; H04N 21/4784; G06Q 30/0226; H04M 1/72439

(57) ABSTRACT

The embodiments herein provide a method and system that helps a user of a vehicle to issue an alert message to his/her contacts present in the vicinity of user's geo-location informing them about an event of being pulled over by police or safely making to his/her home. The method further enables the user to record and share media, and go live telecasting the event of being pulled over.

### TECHNICAL FIELD

The present invention relates generally to a warning or alerting system. More specifically, the present invention discloses a system and method that helps a user of a vehicle to issue an alert or warning message to his/her contact(s) present in a vicinity of the user's geo-location informing them about an event of being pulled over by a police or safely making to his/her home.

### BACKGROUND

In general, traffic stops can be stressful and potentially dangerous for both law enforcement officers and for drivers. At an outset of the traffic stop, the law enforcement officers do not know who or what they are going to see when they approach a vehicle. Likewise, a driver may be on edge and unsure of how the law enforcement officers may react when reaching the vehicle (i.e., state of mind of the law enforcement officers). Depending upon the state of mind of the officers conducting the traffic stop, sometimes, the officers may prove to be less strict and after routine check of documentations or paperwork, the officers may let the driver go free instantly or after a short detention period. However, many times, the drivers may encounter strict officers who may not allow the drivers to go free unless suspicion of the officers is completely cleared. In such scenarios, the drivers may be pulled over for a longer time period. This situation can be stressful for the drivers as well for the drivers' family who might be waiting for the drivers to reach home safely. The longer the pulled over period, higher is the stress for the drivers and their families. Sometimes, a driver may be in urgency of reaching home or some other destination and such unpredictable traffic stop/pulling over can be very annoying for the driver. In such instances, it becomes essential for the driver to be able to alert or notify his (or her) contacts about the traffic stop he (or she) has encountered so he (or she) can receive some immediate help if needed or notify if he (or she) has been released, or he (or she) has safely made home. In the light of foregoing, there is a need for a system and method for a user of a vehicle to issue an alert message to his/her contacts present in the vicinity of user's geo-location informing them about an event of being pulled over by police or safely making to his/her home.

### SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

It is an objective of the present invention to provide a software program product, system, or method that would enable a user of a vehicle to issue an alert or warning message to his/her contacts present in the vicinity of the user's geo-location informing them about an event of being pulled over by a police officer or safely making to his/her home.

It is another objective of the present invention to provide an application that when configured in a user communication device (e.g., a mobile phone or an infotainment device) facilitates the user to broadcast an alert or warning message informing his/her contacts located in the vicinity of the user's geo-location about an unfortunate traffic stop encountered by him/her during the travel.

It is another objective of the present invention to enable a user of a vehicle to record media (e.g., take photos or record videos) at a place of pulled over and optionally upload the recoded media for cloud storage and share the same with other users of the system. It is another objective of the present invention to enable a user of a vehicle to go live and share live videos of the place of detention or pulled over with other users of the system.

It is another objective of the present invention to notify a user of a vehicle about detention of some other accused users of the system located in the vicinity of the user and enable the user to add the other accused users as his/her friends.

It is another objective of the present invention to provide an application for configuration in a user communication device (e.g., a mobile phone or an infotainment device). The application is continually running on the user communication device and may be used by a user of a vehicle to issue an alert or warning message to alert or warn frequent contacts and surrounding members present in the vicinity of the user's geo-location. When the alert or warning message is issued, the application may be configured to generate and send an appropriate alert communication of nearby inappropriate events or crimes to the user's contact and the surrounding members. Further, post the release of the user from the police custody or the traffic stop, the application may be configured to generate and send an appropriate “released” and “made it home” communication to the user's contact. The application is also capable of integrating with the device camera, thereby providing the camera feature to assist the user who is pulled over. The camera may be utilized by the user to record media (e.g., photos or videos) at the place of pulled over and share the recorded media with the user's contact and the surrounding members or optionally upload the recoded media for cloud storage. The camera may be utilized by the user to go live and share live videos of the place of detention or pulled over with other users of the system.

It is another objective of the present invention to reward users who are tuning in to watch live broadcasts of users being pulled over at one or more traffic stops. The users may also be rewarded for arriving the user's location, say, within 50 feet of the user's location. Such users may be rewarded in one or more digital currency or tokens such as cryptocurrency.

These and other features and advantages of the present invention will become apparent from the detailed description below, in light of the accompanying drawings.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 illustrates a computing environment or general implementation of a traffic stop communication system for a user of a vehicle, according to an exemplary embodiment of the present invention.

FIG. 2 illustrates a screenshot of a user interface that shows a geo-location of the user on an electronic map on a user device of the user in real time, according to an exemplary embodiment of the present invention.

FIG. 3 illustrates a screenshot of a user interface that shows the geo-location of the user on the electronic map in real time and an alert event triggered by the user informing contacts in vicinity of the user's geo-location about the user being pulled over, according to an exemplary embodiment of the present invention.

FIG. 4 illustrates a screenshot of a user interface that allows the user to go live and record and/or broadcast a video of a traffic stop location, according to an exemplary embodiment of the present invention.

FIG. 5 illustrates a screenshot of a user interface that allows the user to view all of contacts and contacts who are friends with the user on the proposed program product/application, according to an exemplary embodiment of the present invention.

FIG. 6 illustrates a screenshot of a user interface that allows the user to record media (photos and videos) and upload the same on a cloud server, according to an exemplary embodiment of the present invention.

FIG. 7 illustrates a screenshot of a user interface that shows notifications or alerts received by the user via the proposed program product, according to an exemplary embodiment of the present invention.

FIG. 8 illustrates a screenshot of a user interface that allows the user to review and edit profile, according to an exemplary embodiment of the present invention.

FIG. 9 illustrates a general architecture of the user device wherein the proposed program product or mobile application can be configured to enable the user to access one or more features of the proposed program product or mobile application, according to an exemplary embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event such a component or process is described, but not depicted in a drawing, the absence of such component and process from the drawings should not be considered as an omission of such design from the specification.

Before describing the present invention in detail, it should be observed that the present invention utilizes a combination of components or processes, which constitute a traffic stop communication system and method for a driver of a vehicle. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

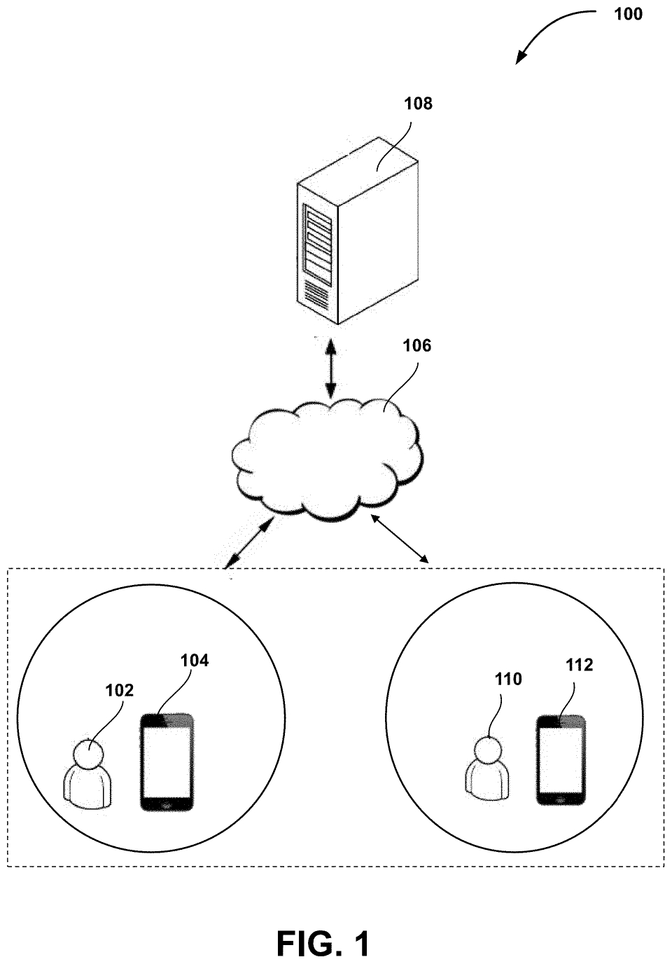

The traffic stop communication system and method for a driver of a vehicle will now be described with reference to the accompanying drawings, particularly FIGS. 1-9.

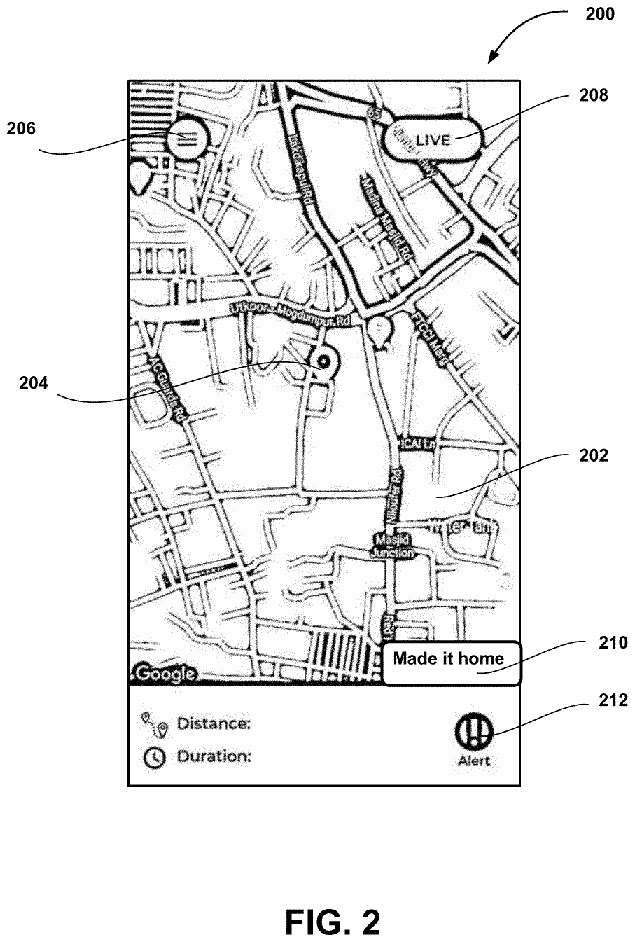

Referring to FIG. 1 in conjunction with FIGS. 2-8, a traffic stop communication system 100 for use by a user 102 is shown. The user 102 uses a user communication device 104 to access all the features and advantages of the proposed system 100. The user 102 is preferably a driver of a vehicle. In context of the present invention, the user communication device 104 refers to an electronic device (such as a smartphone or an infotainment device) that can be used to communicate over the communication network 106.

In an exemplary scenario, the user communication device 104 may embody a mobile application or proposed program product that may fetch data related to the traffic stop communication from a server 108. The server 108 is a computing device, a software framework, or a combination thereof, that may provide a generalized approach to create the application server implementation. Examples of the server 108 include, but are not limited to, a personal computer, a laptop, or a network of computer systems. The server 108 may be realized through various web-based technologies such as, but not limited to, a Java web-framework, a .NET framework, a PHP (Hypertext Pre-processor) framework, or any other web-application framework. The server 108 may operate on one or more operating systems such as Windows, Android, Unix, Ubuntu, Mac OS, or the like. Various operations of the server 108 may be dedicated to execution of procedures, such as, but are not limited to, programs, routines, or scripts stored in one or more memory units for supporting its applied applications and performing defined operations. The network 106 may include suitable logic, circuitry, interfaces, and/or code, executable by the circuitry that may be configured to transmit messages and requests between various entities, such as the application server 108 and the user computing devices 104. Examples of the network include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment may connect to the network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

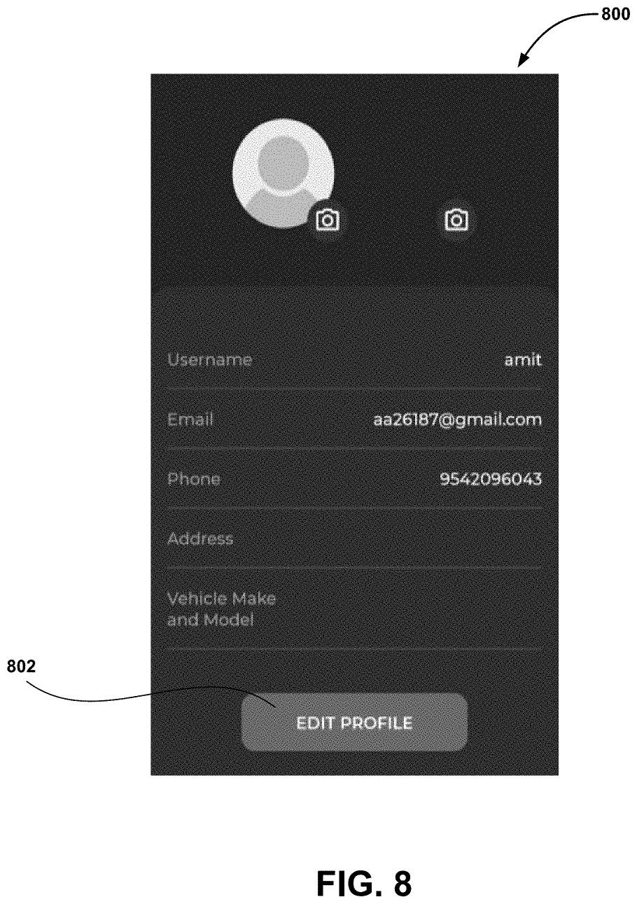

In an embodiment, the proposed program product is stored in the server 108. In an embodiment, the server 108 is a cloud server that has all computing and storage capabilities and is configured using one or more computer components such as memory, processors, software programs, etc. The server 108 stores profile information of the user 102. As seen in FIG. 8, the profile information of the user 102 may include, but is not limited to, a username, an email address, a phone number, an address of the user, a vehicle's make, and a vehicle model that may be inputted by the user 102 while creating his/her profile. The user 102 is also provided with an option to edit or update 802 his/her profile.

In an embodiment, the registered user 102 of the system 100 is able to access the features of the proposed program product or application using the device 104. Registration process for becoming a registered user is omitted herein to keep the description concise considering it is well known in the art. However, without limitation, the user may download the proposed program product or application from the server 108 and then may install the proposed program product or application on the device 104. Thereafter, the user may enter one or more profile information to register with the proposed program product or application facilitated by the server 108. Upon successful installation and registration, the user may login into the proposed program product or application by using the valid login credentials such as email ID, mobile number, or user ID, along with a valid password. Upon successful login, the user 102 is able to locate himself on an electronic map 202 running on the device 104 in real-time. The map 202 is displayed by the application running on the device 104. The user 102 is provided with an option to send/transmit alert message to his contacts located in the vicinity of geo-location of the user 102 using a tab 212 or 210. The alert message is sent, when the user 102 potentially encounters a traffic stop situation or is pulled over and/or sends an alert message when he/she safely makes to home. The user 102 is further provided with an option 208 that enables the user 102 to go live and share live videos of the place of detention or pulled over. Further, the user 102 is enabled to record media (e.g., take photos or record videos) when the need be at the place of pulled over and optionally upload the recoded media for cloud storage and share the same with other users of the system.

In an embodiment, the application is continually running on the user device 104 and may be used by the user 102 of the vehicle to issue an alert or warning message to alert or warn frequent contacts and surrounding members present in the vicinity of the user's geo-location such as the user 110 with the user device 112. When the alert or warning message is issued by the user 102, the application may generate and send an appropriate alert communication of nearby inappropriate events or crimes to the user's contact and the surrounding members. Further, post the release of the user 102 from the police custody or the traffic stop, the application may generate and send an appropriate “released” and “made it home” communication to the user's contact. The application is also capable of integrating with the device camera, thereby providing the camera feature to assist the user 102 who is pulled over. The camera may be utilized by the user 102 to record media (e.g., photos or videos) at the place of pulled over and share the recorded media with the user's contact and the surrounding members or optionally upload the recoded media for cloud storage onto the server 108. The camera may be utilized by the user 102 to go live and share live videos of the place of detention or pulled over with other users of the system. In an embodiment, the users who are tuning in to watch live broadcasts of the user 102 being pulled over at one or more traffic stops may be rewarded by the server 108. The users may also be rewarded for arriving at the user's location, say, within 50 feet of the user's location. Such users may be rewarded in one or more digital currency or tokens such as cryptocurrency. All these features and others will now be explicitly described with respect to the screenshots of FIGS. 2-8.

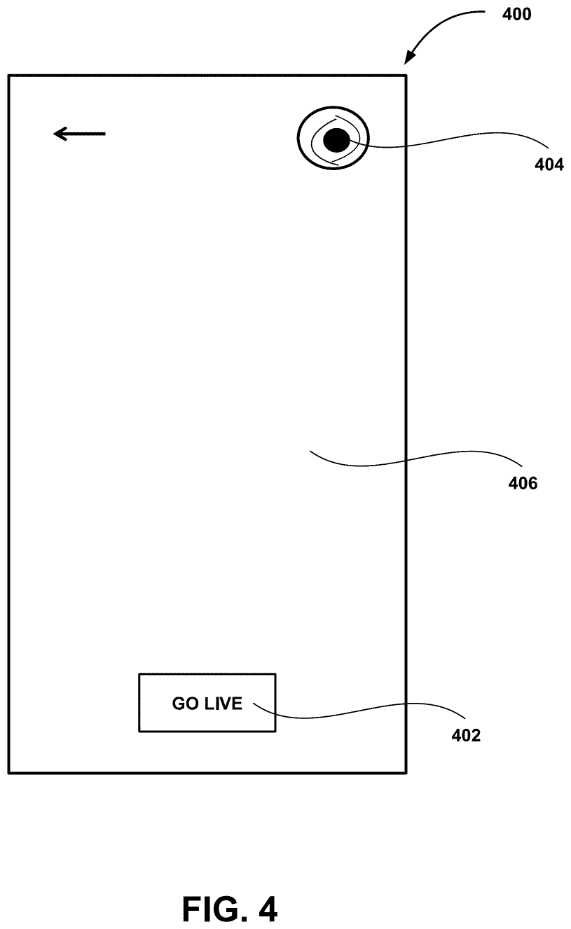

FIG. 2 illustrates a screenshot of a user interface 200 that shows a geo-location of the user 102 on the electronic map 202 in real time, according to an exemplary embodiment of the present invention. Once the user 102 logs into the application, the user 102 can locate his latest location 204 on the map 202 displayed therein. Alternatively, the application may enable the map 202 to automatically locate the current location of the user 102. Apart from this, the user 102 has option to access the menu 206 and navigate through various options or features such as edit profile, view the contact information, record media (such as photos and videos), view notifications, edit privacy setting, update password and so on. Furthermore, the screen 200 also gives an option to the user 102 to go live using the tab 208. Going live feature will be discussed below with respect to FIG. 4. Additionally, the screen 200 provides the user 102 with an option or tab 210 using which the user 102 can transmit an alert message to his contacts informing about the user's status of safely making to his home. This feature greatly helps in relieving stress among the family members or friends of the user 102 who might be waiting for the user 102 to arrive home.

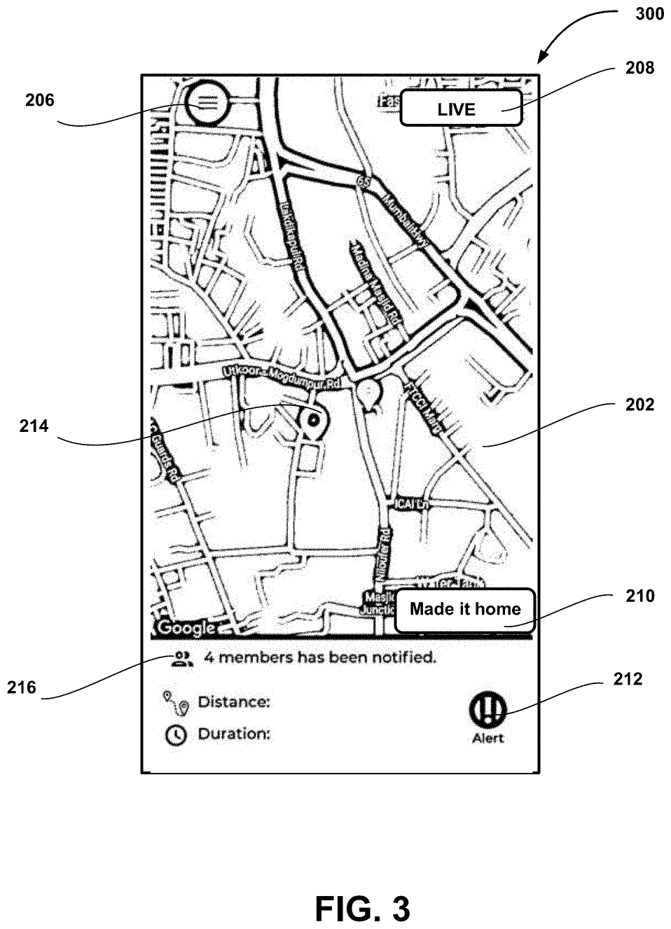

In an embodiment, when the user 102 encounters a traffic stop during his travel, the user 102 can tap on the alert tab 212 to relay a message/notification to the contacts present in the vicinity of the user's latest geo-location 204 informing them about the user 102 being pulled over. Particularly, FIG. 3 shows the screenshot 300, where the user 102 encounters an event of traffic stop at a specific location 214. The traffic stop may be due to stopover by a police officer, or due to traffic congestion, or due to an accident. The user 102 then taps in the alert tab 212 to send an alert to the contacts present nearby or in the vicinity of the latest location 204. As seen in the screenshot 200, the alert notification on the user 102 being detained is sent to four nearby contacts (shown by 216) of the user 102. However, it should be understood that the alert notification may be sent to any number of contacts present within a defined territory or region around the current location 204 of the user 102. The defined region or territory may be certain radium around the location of the user 102.

FIG. 4 illustrates a screenshot of a user interface 400 that allows the user 102 to go live and record and/or broadcast a video of a traffic stop location, according to an exemplary embodiment of the present invention. Once the user 102 taps on the button 208 after logging into the application, the user 102 encounters the screen 400 shown in FIG. 4. The user 102 can then click on the GO LIVE button/tab 402 to turn ON the camera of the device 104 and record and/or telecast the live video. The user 102 can toggle the tab 404 to record normal video or selfie video. The video being recorded would appear in the area 406 of the screen 400. The camera may be utilized by the user 102 to record the media (e.g., photos or videos) at the place of pulled over and share the recorded media with the user's contact and the surrounding members or optionally upload the recoded media for cloud storage onto the server 108. The camera may be utilized by the user 102 to go live and share live videos of the place of detention or pulled over with other users of the system. In an embodiment, the users who are tuning in to watch live broadcasts of user 102 being pulled over at one or more traffic stops may be rewarded.

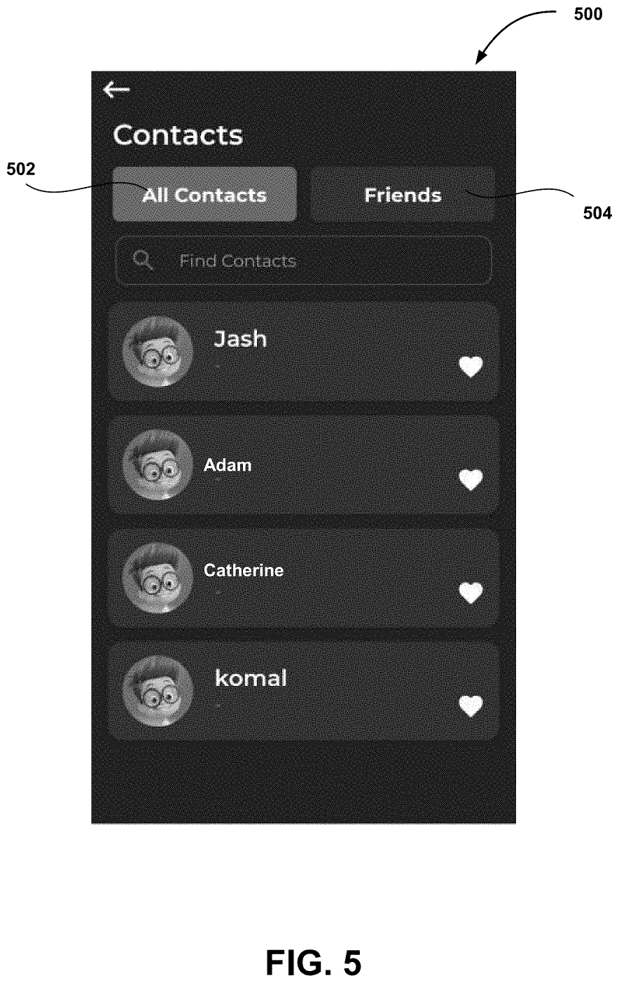

FIG. 5 illustrates a screenshot of a user interface 500 that allows the user 102 to view all of his contacts and contacts who are friends with the user 102 on the proposed program product/application, according to an exemplary embodiment of the present invention. The screenshot 500 provides the user 102 with an option 502 to view all of his contacts. The contacts are basically the contacts present in the address book or phonebook of the user communication device 104 associated with the user 102. In the example, Jash, Adam, Catherine, Komal are shown to be the contacts of the user 102. Optionally, the user 102 if desired can select the contact and invite the selected contact to join the application program. Furthermore, the user 102 is provided with an option 504 to view his friends or connections who are also the members of the application.

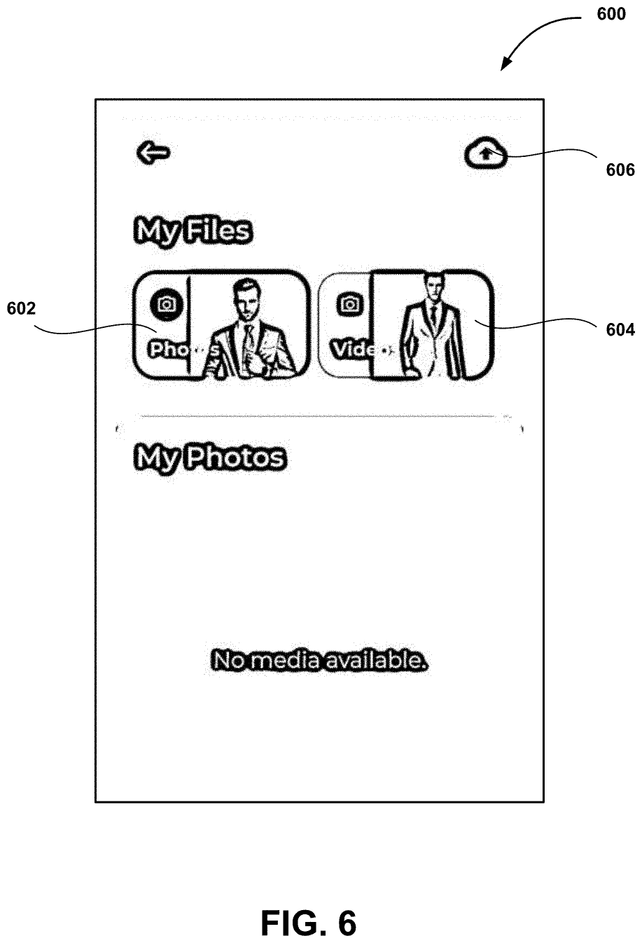

FIG. 6 illustrates a screenshot of a user interface that allows the user 102 to record media (photos, and videos) and uploads the same on the cloud server 108, according to an exemplary embodiment of the present invention. As shown in the screenshot 600, the user 102 is able to take photos using the camera option 602 and the user 102 is also able to record videos using the camera option 604. There can be two separate options to capture photos and record videos, or alternatively, the application may provide a single camera option for capturing the photos and recording the videos. Preferably, this option/features helps the user 102 during traffic stop conditions to capture or record some important activities of the police officers with whom the user 102 might be dealing with. All the captured photos and videos are stored in the server database and can be retrieved by the user 102 as and when necessary. Also, the user 102 is enabled to upload the captured photos or recorded videos on cloud 606 instantly or at any time. In some embodiment, the user 102 is able to share such captured photos and recorded videos over different social networking sites or is able to email to some intended recipients.

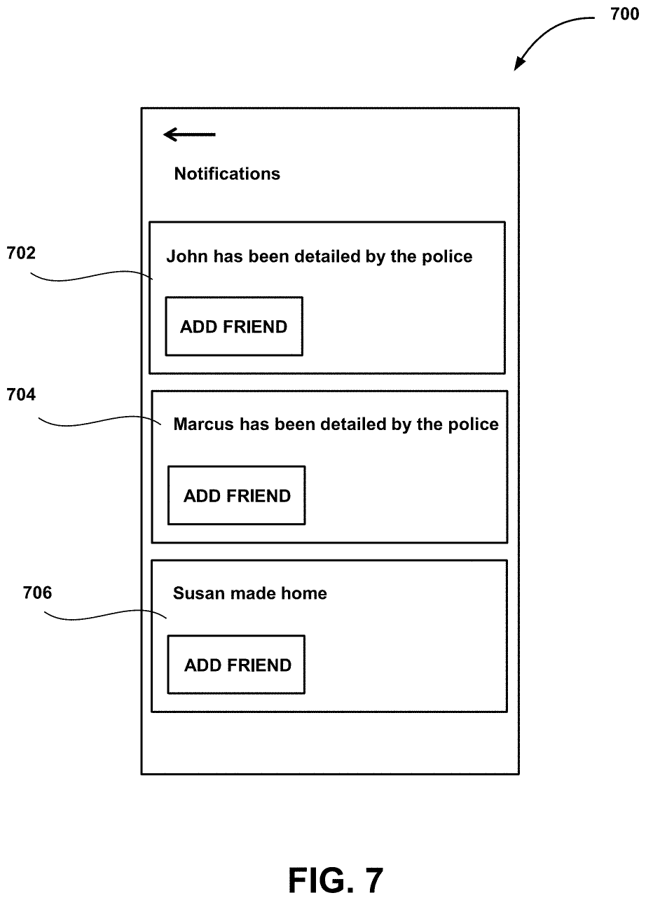

FIG. 7 illustrates a screenshot of a user interface 700 that shows notifications or alerts received by the user 102 via the proposed program product or application, according to an exemplary embodiment of the present invention. Referring FIG. 7 along with FIG. 1, the screenshot or notification widow 700 in particular showcases alert messages received by the user 102. The alerts are generally relayed/transmitted to the user 102 via the server 108, while the user 102 is in vicinity of an accused user. Accused user in the context of this ongoing example is the user 110 having the user communication device 112 (or any user other than the user 102) who is getting pulled over by the police for some crime or violation. According to the embodiment, the alert message may be one that would notify the user 102 that the accused user 110 has been detained by the police and/or the alert message may be one that would notify the user 102 that the accused user 110 has been released or moved on from the traffic stop. Additionally, the user 102 may be notified on the accused user 110 who has made home safely. There can be several other alert messages that may be relayed to the user 102 by the accused user 110. In some embodiment, the alert messages may be custom messages that would be hand typed by the accused user 110. In some embodiments, these alert messages may be default messages that would be auto sent by the server 108 to the contacts (present within the vicinity of geo-location) of the accused user 110. The user 102 being one of the contacts of the accused user 110. In an example shown, John and Marcus can be considered to be accused users 110 who have been detained and this notification is relayed to the user 102 (as the user 102 is present within the vicinity of the geo-location of John and Marcus) over the user communication device 104 via the application. In another example, Susan can be considered as another accused user 110 and the message from the Susan is relayed stating she has made home safely to the contacts (the user 102 being one of the contacts) present within the vicinity of the Susan's latest geo-location when she reached home.

Further according to the embodiment, when the user 102 receives an alert message from the accused user 110, the user 102 is allowed to add the accused user 110 as his friend and be connected. Once the accused user 110 has been added as friend, then the user 102 is connected with the accused user 110 who is also member of the application or proposed platform. The user 102 can then view all of the contacts as friends on a separate window as shown in FIG. 5. Also, once connected with accused user 110 who is friend of the user, the user 102 can get all latest update on the journey of the accused user 110. For example, when the user 110 is released or moves on, or when the accused user 110 safely made to home, the user 102 will get notified by the server 108.

Besides the features discussed above with respect to FIGS. 2-8, the proposed program product or platform enables the user 102 to change privacy settings for the emails or messages that would be sent to the contacts, profile picture of the user, phone number of the user, address of the user, and vehicle related information.

Examples of the user communication device 104, 112 include, but are not limited to a cell phone, a smart phone, a cellular phone, a cellular mobile phone, a personal digital assistant (PDA), a personal computer, a server, a cloud enabled devices, a laptop, and a tablet computer. Examples of types of the communication network 106 shown in FIG. 1 include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), 4G, Long-Term Evolution (LTE), an enhanced data GSM environment (EDGE) and a Universal Mobile Telecommunications System (UMTS). In an embodiment, the phishing email is trigger automatically by an automated system and the response to the phishing email is stored automatically.

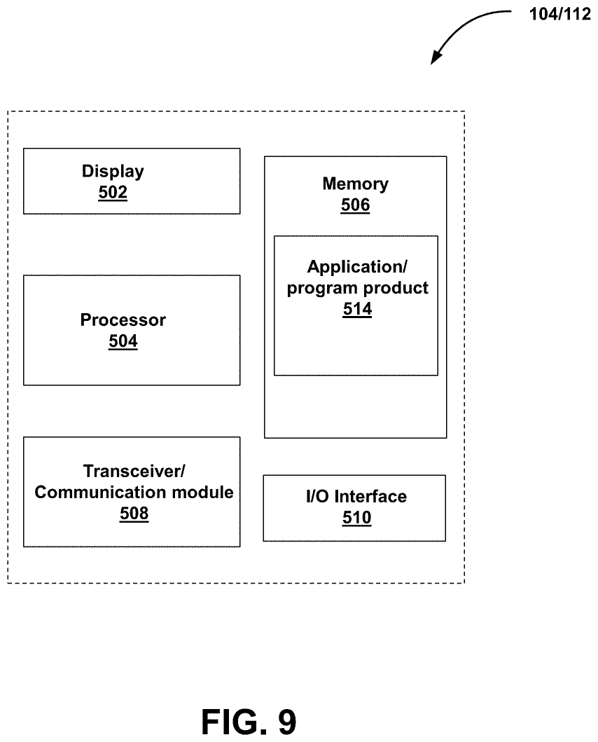

FIG. 9 illustrates the user communication device 104/112 for the user 102, 110 to participate in the traffic stop communication, according to an exemplary embodiment of the present invention. As shown in the FIG. 9, the user communication device 104/112 may include at least one display 502, one or more processors 504, one or more memory, such as memory 506, a transceiver or communication module 508, one or more I/O interfaces, such as an I/O interface 510, a proposed application/program product 512 with set of instructions that would offer various features discussed above with respect to FIGS. 2-8.

The processor 504 may be communicably coupled with the transceiver/communication module 508 to receive inputs from the user 102. Further, the transceiver module 508 may be configured to transmit signals generated by the processor 504 to the display 502. The processor 504 is in communication with the memory 506, wherein the memory 506 includes the app/program product 512 configured in the form of routines, programs, objects, components, data structures and the like, which perform particular tasks to be executed by the processor 504. The proposed program product 512 is configured to enable the user 102/112 to send one or more alert messages discussed above in the foregoing figures above, record media for storage sharing go-live to broadcast or store the event of the traffic stop and so on, all of which discussed above in FIGS. 2-8. The memory 506 stores profile information of the users, captured medias and so on. The user device 104 may be connected to other information processing devices by using the I/O interface 510. The display 502 may be utilized to display various screens (such as screenshots shown in FIGS. 2-8) or other options to the users where user can input command or instructions and receive the output. The I/O interfaces 510 may include a variety of software and hardware interfaces, for instance, interface for peripheral device(s) such as a keyboard, a mouse, a scanner, an external memory, a printer and the like.

In an embodiment, the processor 504 may include different types of processors known in the art including neural network-based algorithms that are effectively used in several applications. In an aspect of the present invention, processor or the neural network may process large amount of data in real-time. In an embodiment, the app/program product 512 may be external to the user devices 104/112. In an alternate embodiment, the app/program product 512 may be part of the server 108.

FIG. 9 is a block diagram that illustrates an architecture of the user device 104/112 for facilitating and managing the various functionalities of the disclosed application, according to an exemplary embodiment of the present invention. An embodiment of the present invention, or portions thereof, may be implemented as computer readable code on the computer system. In one example, the application may be implemented in the user device 104/112 using hardware, software, firmware, non-transitory computer readable media having instructions stored thereon, or a combination thereof and may be implemented in one or more computer systems or other processing systems. Hard-ware, software, or any combination thereof may embody modules and components used to implement the various operations illustrated in the present invention. The user device 104/112 includes the processor 504 that may be a special purpose or a general-purpose processing device. The processor may be a single processor, multiple processors, or combinations thereof. The processor may have one or more processor “cores.” Further, the processor may be connected to a communication infrastructure, such as a bus, a bridge, a message queue, a network, multi-core message-passing scheme, and the like. The computer system further includes a memory such as a main memory and a secondary memory. Examples of the main memory may include RAM, ROM, and the like. The secondary memory may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media. The computer system further includes an input/output (I/O) port or interface 510 and a communication interface 508. The I/O port includes various input and output devices that are configured to communicate with the processor. Examples of the input devices may include a keyboard, a mouse, a joystick, a touchscreen, a microphone, and the like. Examples of the output devices may include a display screen, a speaker, head-phones, and the like. The communication interface may be configured to allow data to be transferred between the computer system and various devices that are communicatively coupled to the computer system such as the user device 104/112. Examples of the communication interface may include a modem, a network interface, i.e., an Ethernet card, a communications port, and the like. Data transferred via the communication interface may be signals, such as electronic, electromagnetic, optical, or other signals as will be apparent to a person skilled in the art. The signals may travel via a communications channel, such as the network, which may be configured to transmit the signals to the various devices that are communicatively coupled to the computer system, such as the tablet device or a mobile phone used by the driver of the vehicle. Examples of the communication channel may include, but not limited to, cable, fiber optics, a phone line, a cellular phone link, a radio frequency link, a wireless link, and the like. Computer program medium and computer usable medium may refer to memories, such as the main memory and the secondary memory, which may be a semiconductor memory such as dynamic RAMs. The main memory or the secondary memory may be used for storing a set of algorithms or instructions for successfully executing one or more features of the application on the user device. These computer program mediums may provide data that enables the computer system to implement the present invention. In an embodiment, the present invention is implemented using a computer implemented application. The computer implemented application may be stored in a computer program product and loaded into the computer system using the removable storage drive or the hard disk drive in the secondary memory, the I/O port, or the communication interface. There is further included an image-capturing device such as a camera that is configured for capturing one or more images or videos of one or more events during or after the stopover.

Although embodiments of the invention have been described in detail for purposes of illustration, various modifications and enhancements may be made without departing from the spirit and scope of the invention.

What is claimed is:

1. An alerting system, comprising:
a first user device of a first user driving a first vehicle, one or more second user devices of one or more second users who are contacts of the first user and are in vicinity of a geolocation of the first user, and a server that are communicatively coupled to each other over a communication network,
wherein the first device is installed with a mobile application downloaded from the server over the communication network,
wherein the mobile application is configured to:
provide a first option to send or transmit an alert message to the contacts of the first user, wherein, when the first user clicks the first option to send or transmit the alert message based on a traffic stop situation or pulled over by a police officer, the mobile application communicates the alert message to the contacts in real time over the communication network; and
provide a second option that enables the first user to go live and share live videos of a place of traffic stop situation or pulled over with the contacts, wherein, when the first user clicks the second option, the mobile application broadcasts the live video with the contacts over the communication network.

2. The alerting system of claim 1, wherein the mobile application for alerting during stopover or pulled over is downloaded by the first user from the server and is installed on the first user device, and wherein, post installation, the first user enters one or more profile information to register with the mobile application facilitated by the server.

3. The alerting system of claim 2, wherein the server stores the profile information of the first user, and wherein the profile information includes a username, an email address, a phone number, an address of the user, a vehicle's make, and a vehicle model of the vehicle of the first user.

4. The alerting system of claim 1, wherein the mobile application is further configured to fetch data related to traffic stop from the server over the communication network.

5. The alerting system of claim 4, wherein the mobile application is further configured to allow the first user to locate himself on an electronic map in real time.

6. The alerting system of claim 5, wherein the mobile application is further configured to enable the first user to record media including photos and videos at a place of pulled over and upload the recoded media for cloud storage and share the same with other users and user's contacts of the system, and wherein the recording of the media is performed by using a camera of the first user device.

7. The alerting system of claim 5, wherein the mobile application is further configured to provide a menu, wherein the first user accesses the menu to navigate through various options including edit profile, view contact information, record media, view notifications, edit privacy setting, and update password.

8. The alerting system of claim 7, wherein the mobile application is further configured to provide a third option using which the first user can transmit an alert message to the contacts informing about the user's status of safely making to his home.

9. The alerting system of claim 7, wherein the server is configured to reward the contacts who are tuning in to watch live broadcasts of the first user being pulled over at one or more traffic stops.

10. The alerting system of claim 7, wherein the reward is provided to the contacts in the form of one or more digital currency or tokens including at least a cryptocurrency.
